(19) United States
(12) Patent Application Publication
(10) Pub. No.: US 2024/0111898 A1
(43) Pub. Date: Apr. 4, 2024

(54) Hybrid Camera System For Oscuring Personally Identifiable Information

(71) Applicant: THE REGENTS OF THE UNIVERSITY OF MICHIGAN, Ann Arbor, MI (US)

(72) Inventors: Yasha IRAVANTCHI, Ann Arbor, MI (US); Alanson SAMPLE, Ann Arbor, MI (US)

(73) Assignee: THE REGENTS OF THE UNIVERSITY OF MICHIGAN, Ann Arbor, MI (US)

(21) Appl. No.: 18/244,574

(22) Filed: Sep. 11, 2023

Related U.S. Application Data
(60) Provisional application No. 63/405,629, filed on Sep. 12, 2022.

(51) Int. Cl. G06F 21/62; G06T 5/50; G06T 5/70; H04N 23/23

(52) U.S. Cl. CPC G06F 21/6254; G06T 5/50; G06T 5/70; H04N 23/23; G06T 2207/20044; G06T 2207/20221; G06T 2207/30201

(57) ABSTRACT

Cameras provide an easy-to-deploy and information-rich datastream for a wide range of ubiquitous sensing and health monitoring applications. However, their unrestricted operation often captures personally identifiable information (PII), preventing their use in privacy-sensitive settings, such as the home, workplace, and hospitals. This disclosure proposes pairing RGB and thermal imaging to robustly detect and remove PII (e.g., an individual's face, skin color, gender, body shape, etc.,) from images before they are stored or sent off the device. A dual camera prototype includes an onboard embedded GPU capable of performing real-time privacy sanitization tasks at 8FPS at under 5 W power consumption. Results show that in the most fail safe settings the system completely removes all PII. In more permissive settings that maintain full compatibility with downstream computer vision methods, 99% of faces are successfully sanitized, facilitating privacy-preserved exercise tracking, in-home activity inferencing, and fall detection.

### CROSS-REFERENCE TO RELATED APPLICATIONS

This application claims the benefit of U.S. Provisional Application No. 63/405,629, filed on Sep. 12, 2022. The entire disclosure of the application referenced above is incorporated herein by reference.

### FIELD

The present disclosure relates to a hybrid camera system for obscuring personally identifiable information.

### BACKGROUND

Cameras are arguably one of the most information-rich sensors. Their ubiquity, paired with advances in computer vision (CV), has demonstrated the ability to support a wide variety of applications. In public spaces, cameras have been used to map roads, measure traffic conditions, and monitor public infrastructure. On personal devices (e.g., smartphones, tablets), cameras perform face-unlock operations and office tasks such as scanning documents. Additionally, cameras have shown incredible effectiveness as a health sensor in measuring heart rate, respiration rate, fitness tracking, and monitoring activities of daily living.

The development and operation of cameras include unbounded data collection that often unintentionally collects personally identifiable information (PII), which may not even be helpful for the task. For example, in Google Maps, collecting images of roads and buildings often captures people's faces and bodies, which offer no informational value to map products. The artifacts created by cameras, such as images and videos containing personally identifiable information, may present privacy concerns for an individual. For example, the individual may have privacy concerns over the use of general surveillance and wide-angle cameras in their homes and private living spaces. In current models, an “all-or-nothing” approach is utilized where either every single pixel is recorded or the camera is disabled. However, the “all of nothing” approach hinders the adoption of cameras in sensitive areas.

The present disclosure provides a hybrid camera system used to efficiently obscure personally identifiable information at the device level such that personally identifiable information is not recorded to disk or streamed off the device. The hybrid camera system improves user trust and allows cameras to be used in sensitive areas, such as the home.

This section provides background information related to the present disclosure which is not necessarily prior art.

### SUMMARY

This section provides a general summary of the disclosure, and is not a comprehensive disclosure of its full scope or all of its features.

The present disclosure provides a hybrid camera system for removing personally identifiable information of a subject from image data captured by a camera. The hybrid camera system includes a first camera, a second camera, and a graphics processor. The first camera has a field of view. The first camera is configured to capture image data in the field of view and measure black-body radiation in the image data, where the image data includes a first image frame. The second camera has a field of view. The second camera is configured to capture image data in the field of view concurrently with the first camera, where the image data includes a second image frame correlated in time with the first image frame. The second camera operates at a different wavelength than the first camera, and the field of view of the second camera substantially overlaps with the field of view of the first camera. The graphics processor is in data communication with the first camera and the second camera. The graphics processor is configured to receive the first image frame and the second image frame, identify a first set of pixels in the first image frame using the black-body radiation measured by the first camera, where the first set of pixels represent a subject, and identify a second set of pixels in the second image frame by correlating the first image frame with the second image frame, where a location of the second set of pixels corresponds to a location of the first set of pixels in the first image frame. The graphics processor is configured to generate a final image frame from at least one of the first image frame or second image frame, where the final image frame has at least some personally identifiable information of the subject obscured, and display the final image frame on a display.

In the hybrid camera system of the above paragraph, the graphics processor is configured to alter a value of at least some pixels in the second set of pixels and generate the final image frame using the second image frame.

In the hybrid camera system of either of the above paragraphs, the graphics processor is configured to alter the value of at least some pixels in the second set of pixels to zero.

In the hybrid camera system of any of the above paragraphs, the at least some pixels in the second set of pixels correlate to a face of the subject.

In the hybrid camera system of any of the above paragraphs, the graphics processor is configured to replace at least some pixels in the second set of pixels with an object and generate the final image frame using the second image frame.

In the hybrid camera system of any of the above paragraphs, the graphics processor is configured to define a background of the second image frame, create a stick figure using the second set of pixels, and generate the final image frame by combining the stick figure with the background, where the stick figure includes a set of points that correspond to a location of a set of joints of the subject.

In the hybrid camera system of any of the above paragraphs, the graphics processor is configured to replace the second set of pixels with a blur and overlay the stick figure on the blur.

In the hybrid camera system of any of the above paragraphs, the graphics processor is operable to remove at least one of a face, gender, skin color, hair color, or body shape of the subject from the second image frame.

In the hybrid camera system of any of the above paragraphs, the final image frame is generated without storing the first and second image frames or communicating the first and second image frames to another device outside of the hybrid camera system.

In the hybrid camera system of any of the above paragraphs, the first camera is operable to capture a set of the first image frames, the second camera is operable to capture a set of the second image frames, and the graphics processor is operable to generate a set of the final image frames simultaneously with the first and second cameras capturing the sets of first and second image frames.

In the hybrid camera system of any of the above paragraphs, the final image frame is compatible with machine learning.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram of a hybrid camera system in accordance with the present disclosure;

FIG. 2 is a flowchart of a method executed by a graphics processor of the hybrid camera system;

FIG. 3A is an example of an image captured by a color camera of the hybrid camera system;

FIG. 3B is an example of an image generated by the hybrid camera system while the hybrid camera system is in a stick figure mode;

FIG. 3C is an example of an image generated by the hybrid camera system while the hybrid camera system is in a ghost UI mode;

FIG. 3D is an example of an image generated by the hybrid camera system while the hybrid camera system is in a thermal mode;

FIG. 3E is an example of an image generated by the hybrid camera system while the hybrid camera system is in a thermal subtraction mode;

FIG. 3F is an example of an image generated by the hybrid camera system while the hybrid camera system is in a face swap mode;

FIG. 4A is an example of an image of an environment;

FIG. 4B is an example of a thermal image of the environment shown in FIG. 4A;

FIG. 4C is an example of the image of FIG. 4A overlaid with canny lines of the thermal image of FIG. 4B;

FIG. 5A is an example of an image of a subject in an environment;

FIG. 5B is a zoomed-in view of the image of FIG. 5A;

FIG. 5C is an example of a thermal image of the subject in the environment of FIG. 5A;

FIG. 5D is an example of a thermal subtraction image for the subject in the environment of FIG. 5A;

FIG. 6A is another example of an image of a subject in an environment;

FIG. 6B is a zoomed-in view of the image of FIG. 6A;

FIG. 6C is an example of a thermal image of the subject in the environment of FIG. 6A;

FIG. 6D is an example of a thermal subtraction image for the subject in the environment of FIG. 6A;

FIG. 7A is another example of an image of a subject in an environment;

FIG. 7B is a zoomed-in view of the image of FIG. 7A;

FIG. 7C is an example of a thermal of the subject in the environment of FIG. 7A;

FIG. 7D is an example of a thermal subtraction image for the subject in the environment of FIG. 7A;

FIG. 8 is an image of an example hybrid camera system in accordance with the present disclosure;

FIG. 9 is a schematic diagram of the example hybrid camera system of FIG. 8;

FIG. 10A is an example of an image of multiple subjects having varying skin tones and of different genders;

FIG. 10B is an example of a thermal image of the multiple subjects of FIG. 10A;

FIG. 10C is an example of a thermal subtraction image of the multiple subjects of FIG. 10A;

FIG. 11A is an example of an image of a checkerboard;

FIG. 11B is an example of a thermal image of the checkerboard of FIG. 11A, where the thermal image has a first resolution;

FIG. 11C is example of the thermal of FIG. 11B, where the thermal is warped to a second resolution;

FIG. 11D is an example of a checkerboard alignment of the image and thermal image of FIGS. 11A and 11C; and

FIG. 12 is flowchart of the operation for each PrivacySlider mode using the example hybrid camera system of FIG. 8.

Corresponding reference numerals indicate corresponding parts throughout the several views of the drawings.

### DETAILED DESCRIPTION

Example embodiments will now be described more fully with reference to the accompanying drawings.

The present disclosure provides a hybrid camera system that is operable to remove personally identifiable information (PII) of a subject from image data captured by a camera.

Personally identifiable information may be broadly defined as “any representation of information that permits the identity of an individual to whom the information applies to be reasonably inferred by either direct or indirect means” according to the National Institute of Standards and Technology (NIST). Personally identifiable information may include photographic images, fingerprints, handwriting, retina scans, voice signatures, or facial geometry. In contrast, information privacy may be defined as “control over how your personal information is collected and used” according to the International Association of Privacy Professionals (IAPP). While these definitions may overlap, there may be situations in which personally identifiable information and privacy standards diverge. For example, placing a listening device that performs featurization locally, where voice information is not recoverable, without the informed consent of an occupant may be a privacy violation but not a PII violation. While the listening device did not store identifiable information, the occupant did not have control or consent over how the occupant's data or portions of that information was used. Thus, the hybrid camera system utilizes a minimum standard of obscuring personally identifiable information to preserve the privacy of a subject.

Additionally, there may be legal risks and liabilities related to the handling of PII. The hybrid camera system is operable to minimize the amount of personally identifiable information collected and stored.

From a user-centric perspective, clear and concise communication that personally identifiable information is not stored provides an opportunity for researchers and developers to mitigate an individual's concern when using privacy-invasive sensors, such as cameras. Several applications utilize cameras and need information that contain personally identifiable information to create PII-free features, such as pose landmarks from body images. Additionally, the raw artifacts (images and video) still carry a personally identifiable information cost when stored, especially if not needed again. However, the hybrid camera system is operable to obscure personally identifiable information before storage or stores only feature representations to provide a compromise between data requirements and privacy needs, allowing a camera to operate safely in a more significant number of areas.

Additionally, a user may be concerned with the location of where the obscuration of personally identifiable information occurs (e.g., locally or in the cloud) and by whom (e.g., algorithmic or human annotators). For example, a smart speaker manufacturer may state that no raw audio leaves a smart speaker after a user issues a voice command. However, the data may be improperly handled such that raw audio does leave the device and is stored on a device. Thus, non-local PII removal may require users to identify and trust all parties who have access to the data, which often is indeterminate due to the design of these systems. However, the hybrid camera system allows users to have a minimum standard of privacy and the ability to define the amount of information collected and stored. Additionally, the hybrid camera system allows users to tailor the hybrid camera system to the user's privacy needs and thus, users are more likely to adopt the hybrid camera system.

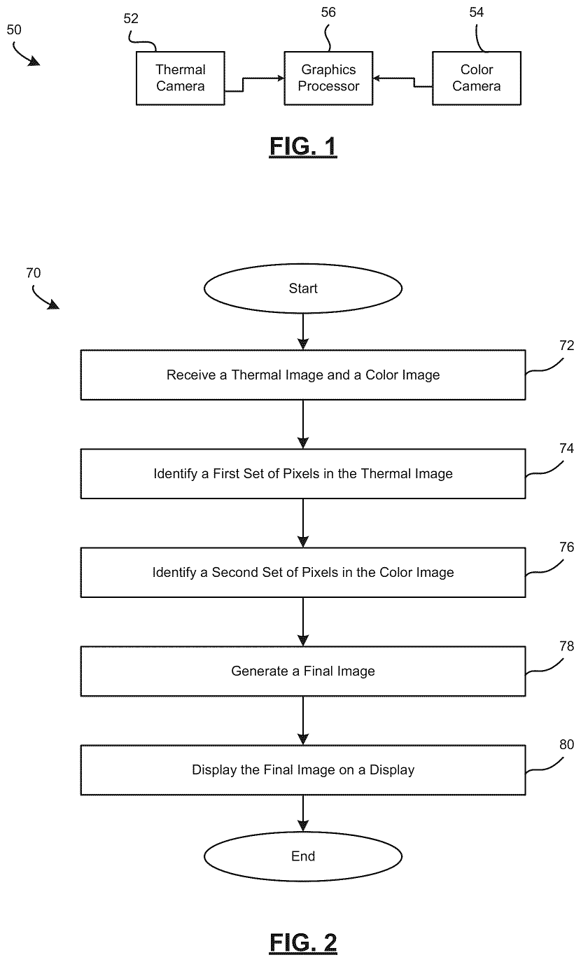

With reference to FIG. 1, a hybrid camera system 50 includes a thermal camera 52 (i.e., first camera), a color camera 54 (i.e., second camera, red green blue camera, RGB camera), and a graphics processor 56.

The thermal camera 52 has a first field of view and is configured to capture image data in the first field of view. The thermal camera 52 operates at a wavelength of about 1000 nm to about 14000 nm and is configured to measure black-body radiation. In one embodiment of the thermal camera 52, the thermal camera 52 captures one image frame such that the image data includes a thermal image (i.e, first image frame). In another embodiment of the thermal camera 52, the thermal camera 52 captures a video and the image data includes a set of thermal images (i.e., set of first image frames). The thermal image is composed of pixels and a value of each pixel is a measure of black-body radiation.

The color camera 54 has a second field of view and is configured to capture image data in the second field of view. The color camera 54 operates in the visible light wavelength and the visible light wavelength ranges from about 400 nm to about 700 nm. In one embodiment of the color camera 54, the color camera 54 captures one image frame such that the image data includes a color image (i.e, second image frame). In another embodiment of the color camera 54, the color camera 54 captures a video and the image data includes a set of color images (i.e., set of second image frames). The color image is composed of pixels and the value of each pixel is a measure of color.

The data processor 56 is in data communication with the thermal and color cameras 52, 54. With reference to FIG. 2, the graphics processor 56 of the hybrid camera system 50 executes a method 70 for obscuring PII from the thermal and color images. In the embodiment where the thermal camera 52 and color camera 54 capture video as the image data, the graphics processor 56 repeats method 70 for each pair of thermal and color images.

At 72, the method 70 includes receiving a thermal image and a color image from the thermal and color cameras 52, 54, respectively. The field of views of the thermal and color cameras 52, 54 substantially overlaps with each other. Accordingly, the thermal and color images capture a common region in an environment. Furthermore, the environment includes at least one subject such that the thermal and color cameras capture the at least one subject in the thermal and color images.

At 74, the method 70 includes identifying a first set of pixels in the thermal image using the black-body radiation measured by the thermal camera. More specifically, the graphics processor 56 is operable to identify the first set of pixels by evaluating the value of each pixel in the thermal image and determining whether the black-body radiation of each pixel meets a range of black-body radiation that can be emitted by a human. Accordingly, the first set of pixels represent the subject.

At 76, the method 70 includes identifying a second set of pixels in the color image by correlating the thermal image with the color image. More specifically, a location of the second set of pixels in the color image is correlated to a location of the first set of pixels in the thermal image. The color camera 54 is configured to capture image data in the field of view concurrently with the thermal camera 52 such that the color image is correlated in time with the thermal image. In one example, the thermal camera 52 operates at the same resolution as the color camera 54. Accordingly, the location of the first set of pixels of the thermal image can be easily correlated with the location of second set of pixels of the color image. In another example, the thermal camera 52 operates at a different resolution than the color camera 54. Accordingly, the thermal and color cameras 52, 54 undergo a calibration process to correlate the location of the first set of pixels in the thermal image with the location of the second set of pixels in the color image. The calibration process will be discussed in further detail below.

At 78, the method 70 includes generating a final image from at least one of the thermal image or the color image. The hybrid camera system 50 operates under at least five (5) modes to generate the final image. More specifically, the hybrid camera system 50 allows a user to choose between different levels of privacy ranging from very restrictive to more permissive depending on their level of comfort and utility of the application. Often, human-centric sensing applications (e.g., in-home activity recognition, health monitoring, fitness tracking) allow computing systems to understand some aspect of the user, which contains private information by nature. However, it is desirable to limit the unnecessary collection of PII that is not required for the end application. Therefore, the hybrid camera system 50 provides manufacturers, researchers, and end-users options on what types of PII data may be captured.

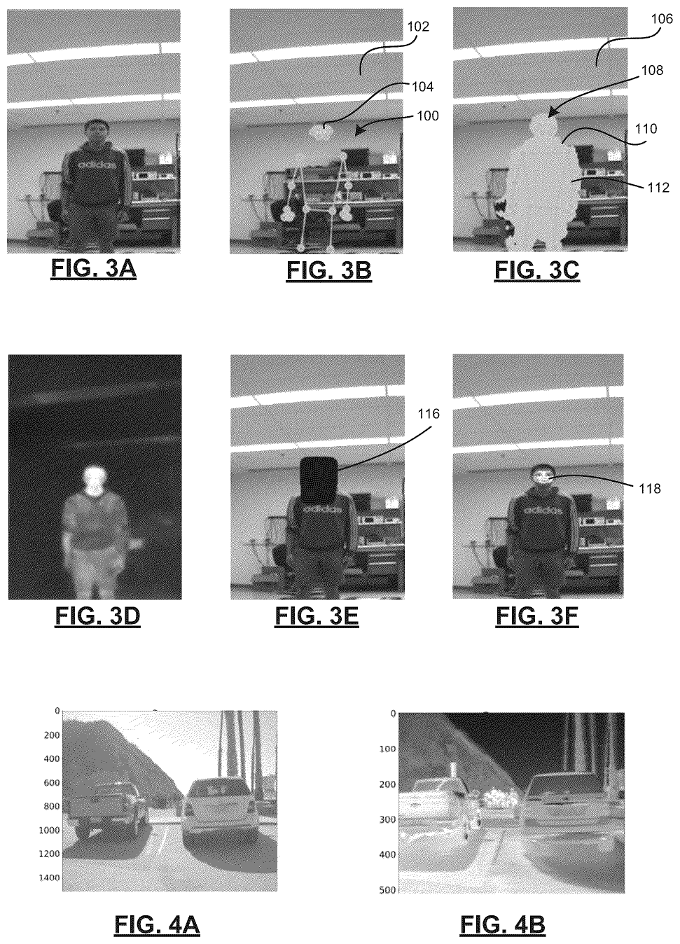

With reference to FIGS. 3A-4F, the five (5) modes used to generate the final image frame include a stick figure mode (FIG. 3B), a ghost UI mode (FIG. 3C), a thermal image mode (FIG. 3D), a thermal subtraction mode (FIG. 3E), and a face swap mode (FIG. 3F). The modes are collectively referred to as the PrivacySlider modes. In contrast with an example of a color image shown in FIG. 3A, the final images shown in FIGS. 3B-3F have at least some PII of the subject obscured.

In the stick figure mode and with reference to FIG. 3B, the graphics processor 56 is configured to create a stick FIG. 100 using the second set of pixels. The graphics processor 56 is configured to define a background image 102 of the color image. Additionally, the graphics processor 56 is operable to identify pose landmarks (i.e., joints) of the subject and illustrate a set of points 104 in the location of the pose landmarks on the stick FIG. 100. The set of points 104 are annotated on the background 100 and thereby, remove the pixels in the second set of pixels that are related to the subject. In the embodiment of the hybrid camera system 50 capturing a video, the stick FIG. 100 and the set of points 104 move according to the live movement of the subject.

In the stick figure mode, the only PII captured is gait and pose. The stick figure mode may be used for applications in private areas, such as a bathroom fall detection, and interactive gesture applications. In the event that the stick figure mode fails, there may be inaccurate or missing points from the set of points 104. However, none of the second set of pixels are exposed. The stick figure mode does not store or transmit images of the user off from the hybrid camera system 50.

In the ghost UI mode and with reference to FIG. 3C, the graphics processor 56 is configured to define a background image 106 of the color image. The graphics processor 56 is configured create a stick FIG. 108 using the second set of pixels and create a human segmentation mask 110 to annotate the background image 106 with a “ghost” (i.e., blur) of the detected subject. Similar to in the stick figure mode, the graphics processor 56 identifies pose landmarks (i.e., joints) of the subject and illustrate a set of points 112 in the location of the pose landmarks on the stick FIG. 108. Accordingly, the human segmentation mask 110 removes the pixels in the second set of pixels that are related to the subject. In the embodiment of the hybrid camera system 50 capturing a video, the stick FIG. 108 and the set of points 112 move according to the live movement of the subject.

In the ghost UI mode, the PII captured is gait, body shape, and pose. The ghost UI mode may be used in less sensitive areas where a body shape of the subject is less of a concern for users and the additional information can be helpful, such as detecting when a subject is using an object in the kitchen or living room and pose-based computer vision (CV) tasks. In the event that the ghost UI mode fails, none of the second set of pixels are exposed.

In the thermal image mode and with reference to FIG. 3D, only the thermal image of the subject is provided. In the embodiment of the hybrid camera system 50 capturing a video, a live thermal image of the subject is provided. While gait and body shape are captured, the thermal camera's low resolution partially obscures face and gender identifiers of the subject. The thermal image cannot capture hair color beyond light or dark. The thermal image mode may be used for applications in large public spaces, such as tracking social distancing and temperature.

In the thermal subtraction mode and with reference to FIG. 3E, the graphics processor 56 is configured to zero a value of at least some pixels in the second set of pixels of the color image. Accordingly, a blur 116 is positioned in the place of the at least some pixels in the second set of pixels. In one example, the at least some pixels in the second set of pixels correlate to a face of the subject. In another example, the graphics processor 56 is configured to zero a value of all pixels in the second set of pixels. Accordingly, the blur 116 extends to all pixels associated with the subject (i.e., entire body of the subject). The thermal subtraction mode may adjust a temperature threshold and dilate/erode values to set the blur 116 to remove faces only or entire bodies with an additional buffer.

In the thermal subtraction mode, the level of PII captured ranges from all except face if only the face is removed to no PII captured if the whole body is removed. The thermal subtraction mode may remove a face, clothes over warm body parts, exposed appendages, and skin color. The thermal subtraction mode may be useful for applications in which subjects are not required for the task and would need to be manually removed from the image, such as capturing images for Maps or monitoring public spaces. In the event that the thermal subtraction mode fails, there may be incomplete obscuration of PII from the color image. However, no raw image data is provided in failure mode.

In the face swap mode and with reference to FIG. 3F, the graphics processor 56 is configured to replace at least some pixels in the second set of pixels with an object 118. In one example, the at least some pixels in the second set of pixels correlate to a face of the subject. Accordingly, the graphics processor 56 is operable to position the object in place of the face of the subject. The object may be a humanoid animated character, such as a smiley face, thereby making it compatible with most downstream computer vision applications. While the face swap mode robustly removes the subject's face and fails-safe when the algorithm breaks, the face swap mode reveals PII in the form of skin tone, gender, and body shape.

In one example, the graphics processor 56 utilizes a MediaPipe's FaceMesh detector to identify 468 face landmarks in a preselected face image. The hybrid camera system 56 may use astronaut.png from the SciKit-Learn library as a default face. The face in the color image is identified and landmarks of the face are identified. Since the landmarks are static, the hybrid camera system 56 may match keypoints and perform a perspective transform of a face template to the face in the color image. Accordingly, the hybrid camera system 56 replaces all pixels corresponding to the face of the subject in the color image with a warped face template. This approach allows facial PII to be removed while maintaining compatibility with many downstream CV methods, such as pose and face landmark detectors. The face-swapped images may be compatible with MediaPipe's Pose and Facemesh detectors, OpenPose, and iOS's Camera App's built-in face detector. To restrict the Face Swap failure mode, a high value for MediaPipe facial landmark detection threshold may be used. If the hybrid camera system 50 cannot perform a face swap at high confidence, the hybrid camera system 50 defaults to the thermal subtraction mode. The face swap mode may be useful for CV researchers, as it is a near-perfect drop-in replacement for a wide variety of applications.

Returning to FIG. 2, the method 100 includes displaying the final image at 80 on a display associated with the camera system. Additionally or alternatively, the hybrid camera system 50 encodes the final image (OpenCV imencode, JPEG Quality 90%) and sends the final image over a network to a remote device. No image, either raw or obscured, is recorded to a disk. In one example, the final image frame can be AES encrypted while still in a memory of the graphics processor 56 for additional security.

With reference to FIGS. 4A-7D, a pilot study for developing the hybrid camera system 50 was conducted. The pilot study included a thermal subtraction evaluation using a FLIR Advanced Driver Assistance System (FLIR ADAS) dataset and an embedded device evaluation.

The thermal subtraction evaluation using the FLIR ADAS dataset will now be discussed. Autonomous driving applications have long sought to improve person detection and operational safety but have found color camera-only approaches to be insufficient and thus have looked outside of the visible spectrum. Common approaches include LIDAR (both UV and infrared), GHz Radar, near-infrared cameras, as well as long wavelength thermal imaging. While many autonomous driving datasets are proprietary, Teledyne FLIR LLC has developed the FLIR ADAS dataset to motivate the use of thermal cameras for autonomous driving applications. The FLIR ADAS dataset includes 28,000 bounding box annotations of persons. This large corpus of data allows users to perform small-scale experiments to test the viability and performance of robustly detecting humans and obscuring personally identifiable information in images.

In the thermal subtraction evaluation, a subset of images that contain at least one annotated person is selected. Since the FLIR ADAS datasheet does not provide a reference image pattern to easily align the image pair, a perspective transform is performed to align the images using an image pair with sharp Canny features in both color and thermal images. FIGS. 4A-4C illustrate an example of the perspective transform. More specifically, FIG. 4A provides an example color image and FIG. 4B provides an example thermal image. The color image shown in FIG. 4A is overlaid with canny lines of the thermal image of FIG. 4B to create the image shown in FIG. 4C.

It is assumed that the cameras remain in a fixed position for the entire dataset, allowing the use of bounding box coordinates of the annotated thermal images for the color images.

A computationally simple approach is used. The approach creates a mask based on the average body temperature of humans to segment images according to Algorithm 1. In Algorithm 1, a lower temperature threshold and an upper temperature threshold is set. In one example, the lower temperature threshold is 92 degrees Fahrenheit and the upper temperature threshold is 105 degrees Fahrenheit. A mask is created for a first set of pixels in the thermal image that have a measured black-body radiation between the lower temperature threshold and the upper temperature threshold. A location of the first set of pixels is correlated to a location of a second set of pixels in the color image (RGB image). The second set of pixels are removed from the color image. In other words, a value of the second set of pixels is set to zero. Accordingly, a thermally subtracted image (i.e., final image) is generated from the color image.

Algorithm 1: Thermal Subtraction Algorithm

| | |
|---|---|
| 1. | Inputs: |
| | aligned_thermal_im, aligned_rgb_im |
| 2. | |
| 3. | Create binary mask (lower_mask) from thermal image lower |
| | temperature threshold |
| 4. | Create binary mask (upper_mask) from thermal image upper |
| | temperature threshold |
| 5. | Invert (Bitwise_NOT) upper_mask |
| 6. | Create binary mask (final_mask) by Bitwise_AND(lower_mask, |
| | upper_mask) |
| 7. | Invert (Bitwise_NOT) final_mask |
| 8. | Erode final_mask |
| 9. | Dilate final_mask |
| 10. | Convert final_mask to 8-bit RGB image |
| 11. | Bitwise_AND(final_mask, aligned_rgb_im) and return thermal_ |
| | sub_im |
| 12. | |
| 13. | Outputs: |
| | thermal_sub_im |

Since this method does not produce bounding boxes, this approach cannot be evaluated using traditional Intersection over Union (IoU) and mean Average Precision (mAP) methods. Instead, a true positive (TP) is defined when greater than 50% of the pixels in an annotated bounding box have a value of zero. A false positive (FP) is defined when an independent blob greater than 25 pixels is removed outside any bounding box. A false negative (FN) is defined when no blob greater than 25 pixels is identified. No true negatives are provided since all images contain at least one person. The thermal subtraction TP rate is 97.1%, FP rate is 1.7%, and FN rate is 1.2%.

One hundred thermally subtracted images were randomly selected, and a human annotator was asked to score each thermally subtracted image as either a yes or no if the image has been obscured beyond recognition for the following identifiers: face, gender, skin color, hair color, and body shape. Additionally, the human annotator was asked to judge whether extra pixels were removed (i.e., pixels not corresponding to a person) and if the thermal subtraction was aligned correctly to evaluate the quality of the image alignment. Furthermore, the human annotator was asked to note if the thermal subtraction was a complete failure (i.e., none of the identifiers were at least partially obscured).

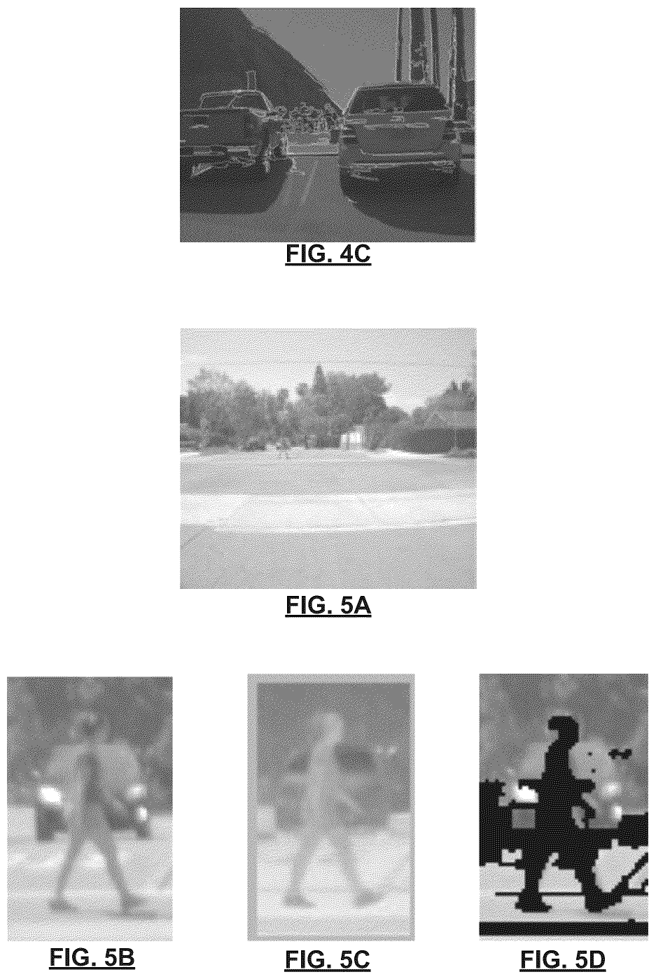

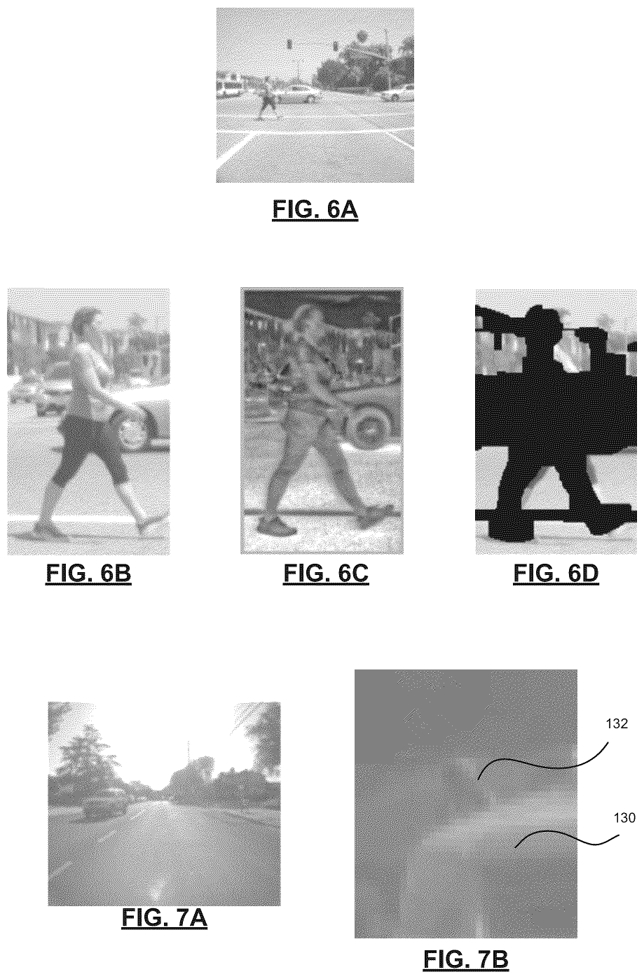

In an example provided in FIGS. 5A-5D, a color image shown in FIGS. 5A-5B and a thermal image shown in FIG. 5C is used to develop a thermally subtracted image (i.e., final image) shown in FIG. 5D. The human annotator was asked to perform the evaluation on the thermally subtracted image of FIG. 5D.

As a result of the human annotator evaluating 100 images, 97% of images had a face of the subject obscured, 93% of images had gender obscured, 91% of images had skin color obscured, 89% of images had hair color obscured, and 91% of images had body shape obscured. 92% of images had extra pixels removed, and 18% had an alignment issue. None of the images had a complete failure. Alignment issues did not lead to personally identifiable information exposure, but all of the images with an alignment issue had at least one personally identifiable information failure and all of the face failures had an alignment issue. Thus, an improved image alignment (or increasing the size of the subtraction mask) may enhance the performance of this approach.

An example of an alignment failure is illustrated in FIGS. 6A-6D. An example of a color image is shown in FIGS. 6A-6B and an example of a thermal image is shown in FIG. 6C. The color and thermal images are used to generate a thermally subtracted image (i.e., final image) shown in FIG. 6D. As illustrated, a low quality alignment between the color image and the thermal image causes the thermal subtraction to partially obscure pixels in the final image that do not correspond to the subject.

For a baseline comparison to an RGB-only approach, an off-the-shelf histogram of oriented gradients (HOG) person detector is used via OpenCV 4.5.2, all parameters default, to find persons in each image. HOG is compatible across many embedded devices in both resource and architectural requirements. HOG is used to provide bounding boxes in the RGB image. A true positive (TP) is defined when a predicted bounding box overlaps with the annotated bounding box with an IoU greater than 0.5. A false positive (FP) is defined when none of the predicted bounding boxes overlap with the annotated bounding box. A false negative (FN) is defined when no bounding boxes are predicted. There are no true negatives. The RGB-alone TP rate is 63.8%, the FP rate is 34.7%, and FN rate is 1.5%.

Though this approach may robustly remove subjects when a subject is correctly identified, a common issue was image quality. More specifically, images were often washed out or blurry and posed a challenge for an RGB-alone method. Additionally, a significant number of false negatives that were observed could be attributed to environmental occlusions of the person, such as by a vehicle, or other lighting conditions that would obstruct a clear view of the person in the color image, such as lens flare. However, the person remained clearly visible in a thermal image.

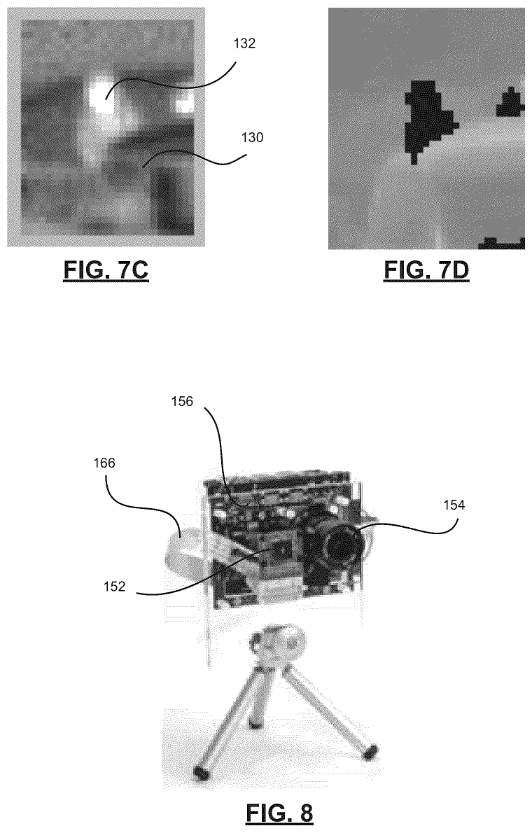

FIGS. 7A-7B illustrate an example of a color image, where an object 130 partially occludes a body of a subject but a face 132 of the subject can be seen. FIG. 7C illustrates a thermal image. FIG. 7D illustrates a thermally subtracted image, where the face 132 of the subject is thermally subtracted. These results, and similar ongoing challenges for autonomous driving research, confirm that using only a color camera is insufficient for a privacy-preserving camera prototype.

The embedded device evaluation will now be discussed. A search for an embedded device was conducted. The search criteria for the embedded device included devices under $100, devices that do not require more power than what Power over Ethernet (PoE) (Type 1, 12.95 W) or USB (5V/3A, 15 W) can provide, devices that are well-documented, and devices that the low-level capability to directly communicate with image sensors over standard serial buss communication protocol such as SPI, I2C, and CSI. A Raspberry Pi 3 at $35 and a Jetson Nano at $100 was selected. The Raspberry Pi 4 was not evaluated because it is not currently supported by efficient GPIO libraries (e.g., Pigpio) and has documented issues with its SPI implementation. The Intel 9900K and Nvidia Titan RTX were included as desktop PC performance references. The relevant packages and libraries from source for each platform were compiled, including optimizations specific to each platform (e.g., NEON for Raspberry Pi, CUDA for Jetson Nano GPU).

The Jetson Nano has two power modes: a MAXN mode, which limits the power budget to 10 W, and a 5 W mode, which limits the power budget to 5 W and disables 2 out of the 4 CPU cores but none of the CUDA GPU cores. For completeness, both settings were evaluated as separate entries.

For the thermal subtraction evaluation, a method using C++ and OpenCV 4.5.2 functions was implemented to enable running identical code across multiple platforms compiled with platform-specific optimizations. Furthermore, all of the OpenCV functions used for the operation have CUDA equivalents, allowing the method to run entirely on GPU and minimizing the CPU contribution when evaluating the GPU's performance. A set of 10 image pairs were created from a pre-processed FLIR ADAS dataset to use across all platforms. All images were preloaded into RAM to avoid introducing differences in disk I/O performance. Finally, thermal subtraction was performed across all 10 images, 10,000 times in total, for a total of 100,000 subtractions, and the average frames per second (FPS) was calculated. During the process, the power consumption of each platform was monitored using a Kill-A-Watt power meter and an increase over idle consumption was reported, allowing for a more direct measure of the task's power consumption and minimizing the effects of power supply efficiency and attached peripherals. The results were used to calculate the efficiency of each platform as FPS/Watt. The findings are provided in Table 1. Overall, the Jetson Nano's CPU and GPU both outperformed the Raspberry Pi. While the Jetson Nano's CPU consumed less power than its GPU, the GPU was significantly more efficient. On the desktop, the Titan RTX consumed more power, yet achieved a much higher efficiency.

TABLE 1
Thermal Subtraction Benchmark

| Device | Watts | FPS | FPS/W |
|---|---|---|---|
| Raspberry Pi 3 | 2.5 | 16.9 | 6.8 |
| Jetson_{CPU} (Max) | 1.6 | 78.1 | 48.8 |
| Jetson_{CPU} (5 W) | 0.9 | 45.3 | 50.3 |
| Jetson_{GPU} (Max) | 2.5 | 259.7 | 103.8 |
| Jetson_{GPU} (5 W) | 2.0 | 221.3 | 110.7 |
| Intel 9900K | 38.0 | 434.0 | 11.4 |
| Titan RTX | 205.0 | 18883.5 | 92.1 |

Since the hybrid camera system 50 may be deployed in environments where subjects are significantly closer to the first and second cameras 52, 54 than in the FLIR ADAS dataset, there may be a better opportunity to perform more fine-grained detection, such as pose and facial landmarks. This allows for better segmentation of images and the potential to replace PII in images, such as replacing a face with a generic face rather than removing entire bounding boxes. MediaPipe presents an efficient framework for various keypoint and detection tasks optimized for close-range and deployment on mobile devices, ideal for our usage cases. Thus, the RGB-based performance evaluation will evaluate how efficiently these devices can perform facial landmark detection.

For the RGB-based facial landmark evaluation, a similar procedure to the previous task is followed. Platform-optimized versions of MediaPipe are utilized and a test image of a person, such as astronaut.png, is loaded from SciKit-Learn into RAM. A facial landmark detection (458 keypoints) task is performed for a total of 100,000 times and the average FPS is calculated. The power consumption is measured and the efficiency is calculated in the same manner as the previous evaluation. The findings are provided in Table 2. This task was challenging for the embedded devices' CPUs because none of the devices could exceed 13FPS. However, the Jetson's GPU achieved up to 50FPS with significantly better efficiency compared to the CPU. Both the CPU and the GPU achieved similar FPS results on the desktop, suggesting an upper FPS limit regardless of resource availability. However, similar to the embedded results, the GPU was more power efficient in performing the same task.

TABLE 2
Mediapipe Facial Landmark Benchmark

| Device | Watts | FPS | FPS/W |
|---|---|---|---|
| Raspberry Pi 3 | 4.6 | 4.8 | 1.0 |
| Jetson_{CPU} (Max) | 2.7 | 12.4 | 4.6 |
| Jetson_{CPU} (5 W) | 0.6 | 3.1 | 5.2 |
| Jetson_{GPU} (Max) | 2.9 | 50.0 | 17.2 |
| Jetson_{GPU} (5 W) | 0.9 | 17.5 | 19.4 |
| Intel 9900K | 95.8 | 226.3 | 2.4 |
| Titan RTX | 59.0 | 229.3 | 3.9 |

Thus, from our preliminary findings in the Pilot Study, it is determined that thermal subtraction presents a promising approach that can perform robust and power-efficient obscuration of PII when paired with an embedded graphics processor.

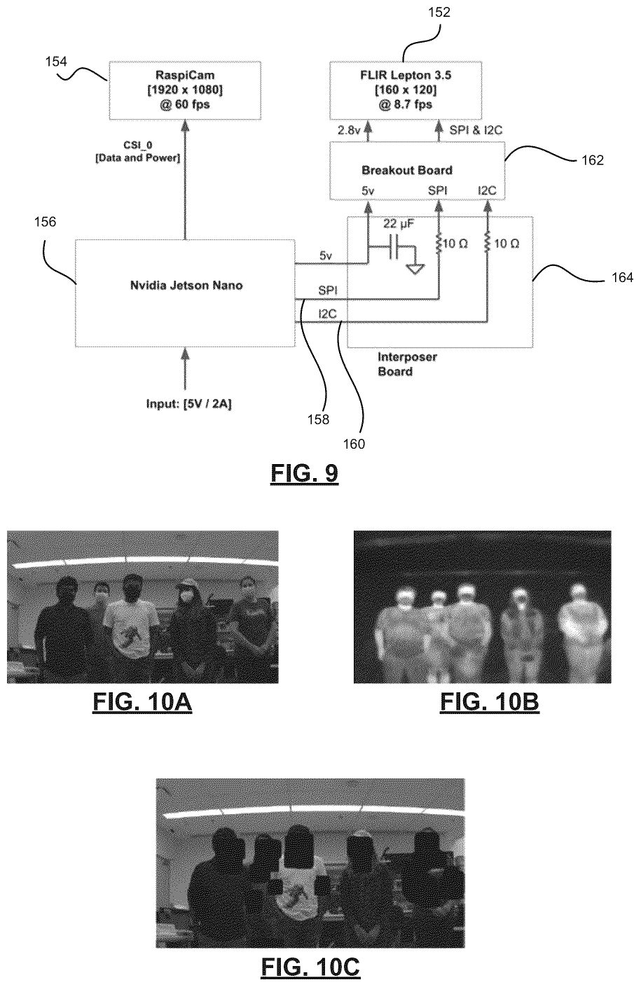

An example embodiment of the hybrid camera system 50 will now be described in greater detail. With reference to FIGS. 8-9, the thermal camera is a FLIR Lepton 3.5 camera 152, the color camera is a Raspberry Pi HQ camera 154 (referred to as RaspiCam), and the graphics processor is a Nvidia Jetson Nano 156. Additionally, a software pipeline captures image data from the thermal and color cameras 152, 154 and efficiently processes the image data on the graphics processor 164 to obscure PII from the color image or thermal image.

The thermal camera 152 captures image data in a first field of view and the image data includes a thermal image. The thermal camera 152 is a radiometric sensor. In other words, a value of each pixel of the thermal image corresponds to an absolute temperature of an environment. The value of each pixel of the thermal image are not relative to the thermal content of the environment. As described above, the thermal camera 152 measures a black-body radiation emitted by the subject. The black-body radiation measurement is not affected by illumination conditions or different skin types. In FIGS. 10A-10C, a color image (FIG. 10A), a thermal image (FIG. 10B), and a thermally subtracted image (FIG. 10C) are shown. The color image of FIG. 10A illustrates five subjects having different skin tones and of different genders. Nonetheless, the thermal camera 152 provides consistent thermal imaging across skin tones and gender and thus, the thermal image of FIG. 10B does not illustrate any inconsistencies in thermal imaging. Returning to FIGS. 8-9, the thermal camera 152 is unlikely to inherit negative racial biases based on skin color. In one example, the thermal camera 152 is operable to capture image frames at a resolution of 160×120 and a frame rate of 8FPS.

The color camera 154 captures image data in a second field of view and the image data includes a color image. In one example, the color camera 154 has a 6 mm lens such that the second field of view of the second camera 154 is closest to the first field of view of the first camera 52. The color camera 154 may include a Sony IMX477 such that an image sensor is positioned with a C-mount. The color camera 154 includes a Camera Serial Interface (CSI) connector for low-level control of the image sensor. The RaspiCam is modified by removing resistor R8 from the RaspiCam and thereby permitting the RESET pin to accept 1.8V signals. A custom camera driver is provided to interface the camera with the Jetson's GPU-accelerated GStreamer pipeline, which efficiently converts the raw RGB10 frames to 8-bit BRG format for OpenCV compatibility. In one example, the color camera 154 is operable to capture image frames at a resolution of 1920×1080 (i.e., 1080p) and a frame rate of 60FPS with all “auto” settings disabled.

The graphic processor 156 provides a SPI communication 158 and an I2C communication 160 to the thermal camera 152 via a breakout board 162. To improve the stability of the 20 MHz-clock SPI transmission, signals may be routed through an interposer PCB 164 and a ribbon cable 166. The thermal and color cameras 152, 154 are mounted along the same Y and Z plane and as close as possible in a lateral side to side direction. The close positioning of the thermal and color cameras 52, 54 enables a close alignment.

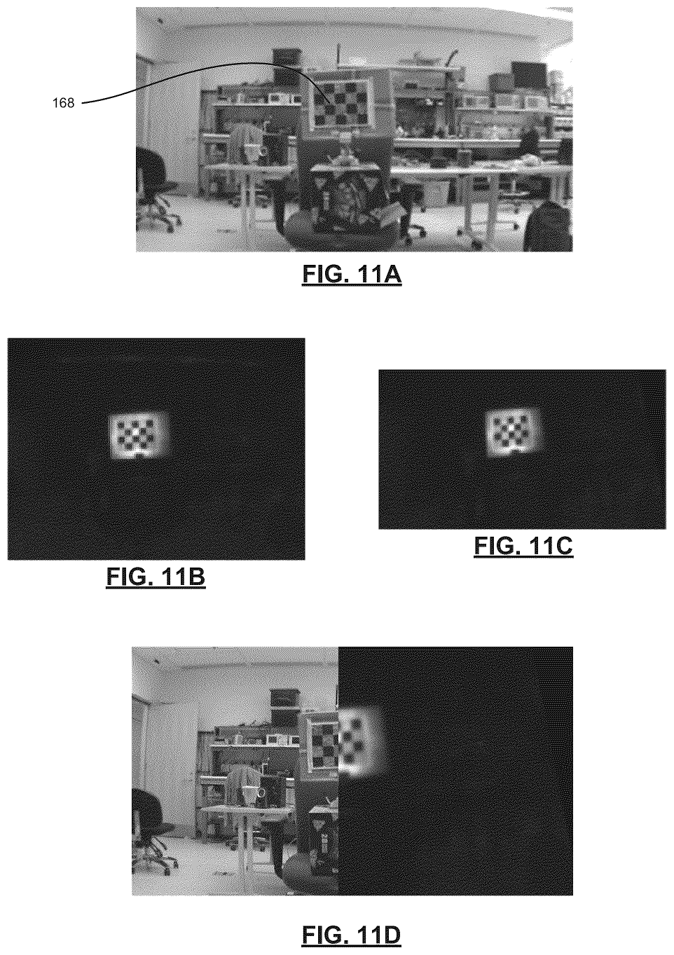

With reference to FIGS. 11A-11D, the calibration process for calibrating the thermal image and color image is now described. A checkerboard 168 is used to align a color image and a thermal image. FIG. 11A provides an example of a color image captured by a color camera and FIG. 11B provides an example of a thermal image captured by a thermal camera, where both the color image and thermal image are of substantially the same environment. In this example, the thermal camera has a smaller resolution than the color camera. The thermal image is warped to the color image to create an aligned mask. An example of the warped thermal image is shown in FIG. 11C.

The checkerboard 168 is fabricated of a first and second material. In one example, the first material is copper, and the second material is paper. The checkerboard 168 creates a matching checkerboard pattern in thermal imaging when heated with a heat gun. The checkerboard 168 may be used to find a homography matrix and perform a perspective transform on the graphics processor 156 to align the thermal image to color image.

As described above, the thermal and color cameras 152, 154 may capture video (i.e, a set of image frames) as the image data. In one example, the thermal camera 152 has a frame rate of 8FPS and the color camera 54 has a frame rate of 60FPS. To time-synchronize the thermal and color cameras 152, 154, the latest color image available from a gstreamer pipeline immediately before requesting a frame from the thermal camera may be used. Accordingly, this produces a worst-case synchronization error of 16.67 ms.

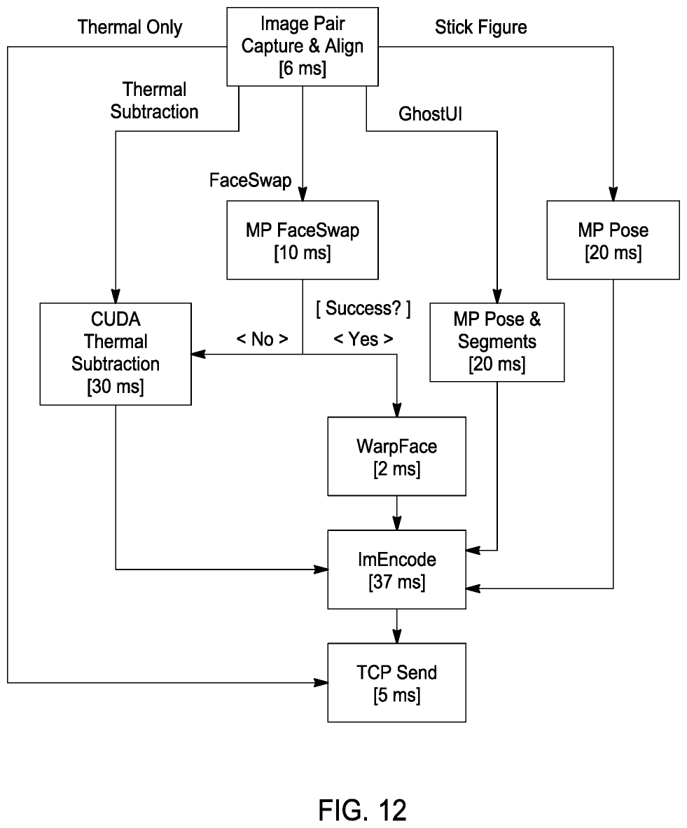

With reference to FIG. 12, a process flow of the hybrid camera system 50 for executing each of the PrivacySlider modes is provided. The average completion time for each operation at 1080p resolution is also provided. At 8FPS, the average consumption of all modes was less than 5 W. Considering stick figure and ghost UI modes do not utilize the thermal camera, the framerate were restricted to 8FPS to match the other modes and limit power consumption. A total bandwith of the processor 156 over ethernet is measured to be 533 Mbps using iperf3 (default settings, TCP mode), which significantly exceeds 2.5 Mbps.

In one example, the hybrid camera system 50 can be used for exercise tracking. Several computer vision-based systems proposed methods of tracking an individual's workout with the goal of automatically identifying the type of exercise, number of repetitions and providing feedback to the user on their technique. In this example, the hybrid camera system in stick figure mode can be used to generate a stick figure with the subject's key points, thereby, obscuring all other personally identifiable information. Even when the key point tracker fails, no PII is collected. The hybrid camera system, along with a workout tracking program running on a networked computer, can track the subject's workout in a home without compromising the subject's privacy.

In another example, the hybrid camera system 50 can be used for activity detection. Effective means of enabling computers to automatically detect and identify a subject's activities in the subject's living spaces has been. Of particular interest is the potential to monitor individuals over long periods to understand changes in health and wellness as people age and live with chronic illnesses. A proof of concept activity detection and inferencing application is designed to track users in a kitchen using the hybrid camera system 50 in Ghost UI mode along with a Yolo real-time object detection system running on a backend server. The hybrid camera system 50 captures a static background image when no users are detected. When users are present, hybrid camera system 50 captures the user's keypoints to create a stick figure along with a human segmentation mask. The hybrid camera system 50 ships the keypoint data and the composite image back to the server. No raw image of the user is stored or shipped off the device. On the server side, Yolo determines the bounding box of common household objects, and the object interaction detection algorithm measures the intersection of hand keypoints and objects of interest. For example, the hybrid camera system 50 can easily identify a user interacting with a microwave, electric oven, and sink. These important object interaction events can be used to build an activity inferencing model of a user's daily routine.

In yet another example, the hybrid camera system 50 can be used for fall detection. Device-free fall detection does not require the subject to wear a fall detection monitoring device continuously. While cameras have been shown to be very capable of detecting falls or people lying down on the floor, many elderly citizens and family members may be reluctant to install cameras in their homes. The hybrid camera system 50 can allow users to see a real-time image of the type of data that is being collected and allows users to select a setting that works best for them. For example, a stick figure of a subject is generated when the hybrid camera system 50 is in stick figure mode. A fall event is when a subject is classified and lying horizontally on the floor. In some examples, the fall event may trigger follow up action.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hybrid camera system for removing personally identifiable information of a subject from image data, comprising:
a thermal camera having a field of view and configured to capture a first image frame in the field of view;
a second camera having a field of view and configured to capture a second image frame concurrently with the thermal camera, such that the second image frame is correlated in time with the first image frame, wherein the second camera operates at a wavelength of visible light and the field of view of the second camera substantially overlaps with the field of view of the thermal camera; and
a computer processor configured to receive the first image frame and the second image frame, identify a first set of pixels in the first image frame that represent the subject, identify a second set of pixels in the second frame that are spatially correlated with the first set of pixels, and obscure personally identifiable information in the second set of pixels, thereby forming a final image frame.

2. The hybrid camera system of claim 1 wherein the thermal camera operates at a wavelength of 1000 nm to 14,000 nm.

3. The hybrid camera system of claim 1 wherein the first set of pixels is identified as pixels having values associated with radiation emitted by a human.

4. The hybrid camera system of claim 1 wherein location of pixels in the second set of pixels matches location of the first set of pixels in the first image frame.

5. The hybrid camera system of claim 1 wherein the second set of pixels correlates to face of the subject.

6. The hybrid camera system of claim 1 wherein the computer processor obscures personally identifiable information in the second set of pixels by setting pixel values to zero.

7. The hybrid camera system of claim 1 wherein the computer process obscures personally identifiable information in the second set of pixels by replacing the second set of pixels with a stick figure, a blur or another object.

8. The hybrid camera system of claim 1 wherein the computer processor further operates to store the final image frame without storing the first and second image frames.

9. The hybrid camera system of claim 1 wherein the computer processor further operates to transmit the final image frame over a network to another device.

10. A hybrid camera system for removing personally identifiable information of a subject from image data, comprising:
a first camera having a field of view and configured to capture image data in the field of view and measure black-body radiation in the image data, where the image data includes a first image frame;
a second camera having a field of view and configured to capture image data concurrently with the first camera, where the image data includes a second image frame correlated in time with the first image frame, the second camera operates at a different wavelength than the first camera, and the field of view of the second camera substantially overlaps with the field of view of the first camera; and
a computer processor in data communication with the first camera and the second camera, the computer processor is configured to:
receive the first image frame and the second image frame,
identify a first set of pixels in the first image frame using the black-body radiation measured by the first camera, where the first set of pixels represent a subject,
identify a second set of pixels in the second image frame by correlating the first image frame with the second image frame, where a location of the second set of pixels corresponds to a location of the first set of pixels in the first image frame,
generate a final image frame from at least one of the first image frame or second image frame, where the final image frame has at least some personally identifiable information of the subject obscured, and
display the final image frame on a display.

11. The hybrid camera system of claim 10, wherein the computer processor is configured to alter a value of at least some pixels in the second set of pixels and generate the final image frame using the second image frame.

12. The hybrid camera system of claim 11, wherein the computer processor is configured to alter the value of the at least some pixels in the second set of pixels to zero.

13. The hybrid camera system of claim 11, wherein the at least some pixels in the second set of pixels correlate to a face of the subject.

14. The hybrid camera system of claim 13, wherein the computer processor is configured to replace the at least some pixels in the second set of pixels with an object and generate the final image frame using the second image frame.

15. The hybrid camera system of claim 10, wherein the computer processor is configured to define a background of the second image frame, create a stick figure using the second set of pixels, and generate the final image frame by combining the stick figure with the background, where the stick figure includes a set of points that correspond to a location of a set of joints of the subject.

16. The hybrid camera system of claim 15, wherein the computer processor is configured to replace the second set of pixels with a blur and overlay the stick figure on the blur.

17. The hybrid camera system of claim 10, wherein the computer processor is operable to remove at least one of a face, gender, skin color, hair color, or body shape of the subject from the second image frame.

18. The hybrid camera system of claim 10, wherein the final image frame is generated without storing the first and second image frames or communicating the first and second image frames to another device outside of the hybrid camera system.

19. The hybrid camera system of claim 10, wherein the first camera is operable to capture a set of the first image frames, the second camera is operable to capture a set of the second image frames, and the computer processor is operable to generate a set of the final image frames simultaneously with the first and second cameras capturing the sets of first and second image frames.
